(19) United States
(12) Patent Application Publication
(10) Pub. No.: US 2010/0038390 A1
(43) Pub. Date: Feb. 18, 2010

(54) Combination Water Bottle Cage having a Modularized Structure

(76) Inventor: Wu-Sung Chang, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/192,330

(22) Filed: Aug. 15, 2008

(51) Int. Cl. F16M 13/02

(52) U.S. Cl. 224/425; 248/201

(57) ABSTRACT

A water bottle cage for a bicycle includes an upper bracket and a lower bracket detachably mounted on the upper bracket. The upper bracket is provided with at least one engaging portion, and the lower bracket is provided with at least one engaging section detachably engaged with the at least one engaging portion of the upper bracket. The upper bracket and the lower bracket are made individually, so that each of the upper bracket and the lower bracket has a modularized structure. Thus, the type, color and pattern of the upper bracket and the lower bracket can be changed freely and selectively, thereby enhancing the aesthetic quality and reinforce the strength of the water bottle cage.

### BACKGROUND OF THE INVENTION

1. Field of the Invention

The present invention relates to a water bottle cage and, more particularly, to a water bottle cage for mounting and supporting a water bottle on a bicycle.

2. Description of the Related Art

A conventional water bottle cage for a bicycle comprises a fixing plate locked on the frame of the bicycle and a support bracket combined with the fixing plate to receive a water bottle for user with a rider on the bicycle. However, the conventional water bottle cage is formed integrally, thereby causing inconvenience in fabrication and production of the water bottle cage. In addition, the conventional water bottle cage only has a single type and color, thereby decreasing the outer appearance of the water bottle cage. Further, the conventional water bottle cage has a larger volume and cannot be detached before assembly or when no in use, thereby greatly causing inconvenience in packaging, storage and transportation of the water bottle cage.

### BRIEF SUMMARY OF THE INVENTION

In accordance with the present invention, there is provided a water bottle cage, comprising an upper bracket and a lower bracket detachably mounted on and combined with the upper bracket. The upper bracket is provided with at least one engaging portion, and the lower bracket is provided with at least one engaging section detachably engaged with the at least one engaging portion of the upper bracket.

The primary objective of the present invention is to provide a combination water bottle cage having a modularized structure.

Another objective of the present invention is to provide a water bottle cage, wherein the upper bracket and the lower bracket are made individually, so that each of the upper bracket and the lower bracket has a modularized structure, and the type, color and pattern of the upper bracket and the lower bracket can be changed freely and selectively, thereby enhancing the aesthetic quality and reinforce the strength of the water bottle cage.

A further objective of the present invention is to provide a water bottle cage, wherein the upper bracket and the lower bracket are detached from each other, so that the upper bracket and the lower bracket can be sold and replaced respectively, thereby decreasing the costs of the water bottle cage.

A further objective of the present invention is to provide a water bottle cage, wherein the upper bracket and the lower bracket are detached from each other to reduce the volume of the water bottle cage before assembly or when no in use, thereby facilitating packaging, storage and transportation of the water bottle cage.

A further objective of the present invention is to provide a water bottle cage that comprises two decorative pieces each mounted between a respective one of the two first clamping plates and a respective one of the two second clamping plates to enhance the aesthetic quality and reinforce the strength of the water bottle cage.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a water bottle cage in accordance with the preferred embodiment of the present invention.

FIG. 2 is an exploded perspective view of the water bottle cage as shown in FIG. 1.

FIG. 3 is a partially rear cross-sectional view of the water bottle cage as shown in FIG. 1.

FIG. 4 is a partially front cross-sectional view of the water bottle cage as shown in FIG. 1.

FIG. 5 is a perspective view of the water bottle cage in accordance with another preferred embodiment of the present invention.

### DETAILED DESCRIPTION OF THE INVENTION

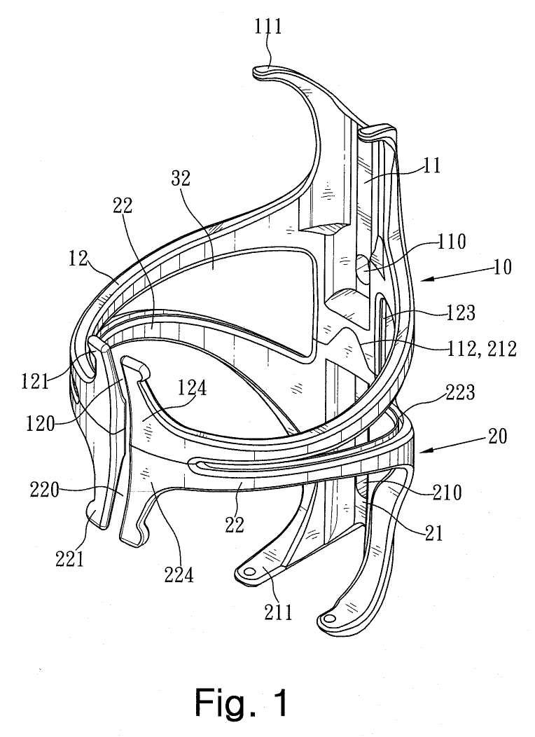

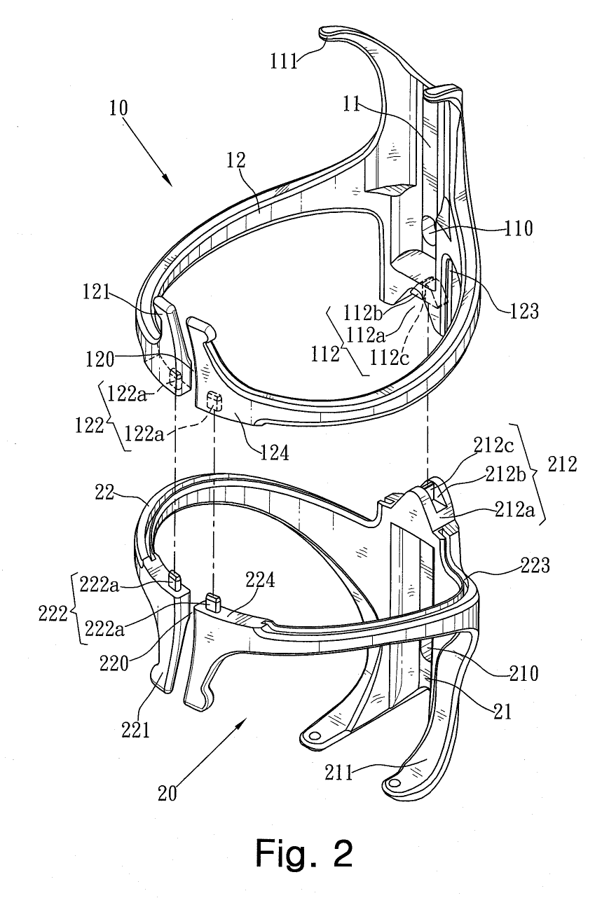

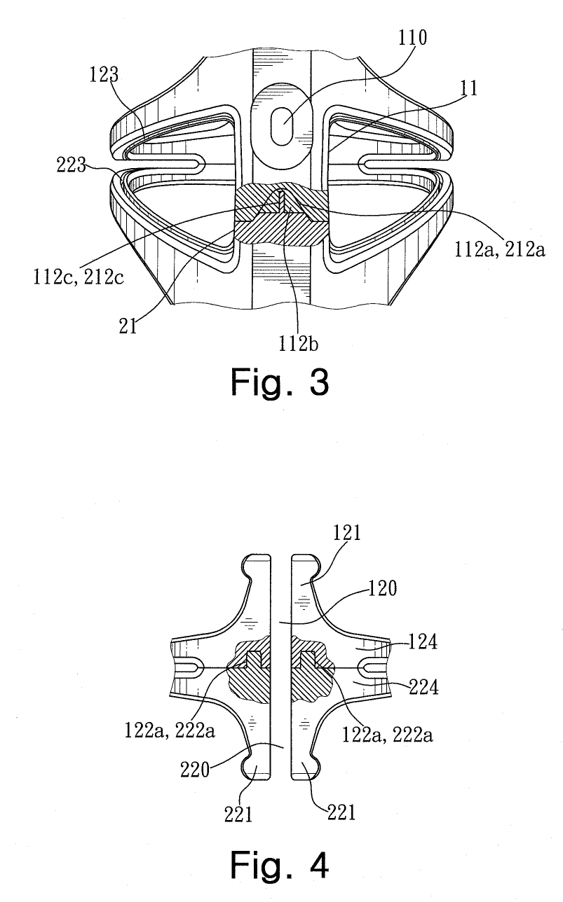

Referring to the drawings and initially to FIGS. 1-4, a water bottle cage for a bicycle in accordance with the preferred embodiment of the present invention comprises an upper bracket 10 and a lower bracket 20 detachably mounted on and combined with the upper bracket 10. The upper bracket 10 is provided with at least one engaging portion 112 or 122, and the lower bracket 20 is provided with at least one engaging section 212 or 222 detachably engaged with the at least one engaging portion 112 or 122 of the upper bracket 10.

In the preferred embodiment of the present invention, the upper bracket 10 is provided with a first engaging portion 112 and a second engaging portion 122 spaced from the first engaging portion 112, and the lower bracket 20 is provided with a first engaging section 212 detachably engaged with the first engaging portion 112 of the upper bracket 10 and a second engaging section 222 spaced from the first engaging section 212 and detachably engaged with the second engaging portion 122 of the upper bracket 10.

The upper bracket 10 has a substantially C-shaped profile. The upper bracket 10 includes a first back seat 11 and two first clamping plates 12 provided on two opposite sides of the first back seat 11. Each of the two first clamping plates 12 of the upper bracket 10 has a substantially arc-shaped profile and has a first end extending outwardly from the first back seat 11. The first engaging portion 112 of the upper bracket 10 is provided on a bottom of the first back seat 11, and the second engaging portion 122 of the upper bracket 10 is provided on a bottom of a second end 124 of each of the two first clamping plates 12. Each of the two first clamping plates 12 of the upper bracket 10 extends from a middle section of the first back seat 11 and is inclined forward and downward in an oblique manner. The second end 124 of each of the two first clamping plates 12 and the bottom of the first back seat 11 are located at the same height. The upper bracket 10 has a first opening 120 defined between the second ends 124 of the two first clamping plates 12. The first engaging portion 112 of the upper bracket 10 includes a concave receiving recess 112a provided on the bottom of the first back seat 11, a protruding insert 112b located in and extended downward from the receiving recess 112a, and a locking groove 112c formed in the protruding insert 112b. The protruding insert 112b of the first engaging portion 112 has a thickness smaller than that of the receiving recess 112a. The second engaging portion 122 of the upper bracket 10 includes two sockets 122a each formed in the bottom of the second end 124 of a respective one of the two first clamping plates 12. The first back seat 11 of the upper bracket 10 has a face provided with a first locking hole 110 and has a top provided with two clamping plates 111 each having a substantially arc-shaped profile and each extending toward the second engaging portion 122. The second end 124 of each of the two first clamping plates 12 has a top provided with a protruding guide block 121, and the guide blocks 121 of the two first clamping plates 12 extend outwardly relative to each other.

The lower bracket 20 has a substantially C-shaped profile. The lower bracket 20 includes a second back seat 21 abutting the first back seat 11 of the upper bracket 10 and two second clamping plates 22 provided on two opposite sides of the second back seat 21 and juxtaposed to the two first clamping plates 12 of the upper bracket 10. Each of the two second clamping plates 22 of the lower bracket 20 has a substantially arc-shaped profile and has a first end extending outwardly from the second back seat 21. The first engaging section 212 of the lower bracket 20 is provided on a top of the second back seat 21, and the second engaging section 222 of the lower bracket 20 is provided on a top of a second end 224 of each of the two second clamping plates 22. Each of the two second clamping plates 22 of the lower bracket 20 extends from a middle section of the second back seat 21 and is inclined forward and upward in an oblique manner. The second end 224 of each of the two second clamping plates 22 and the top of the second back seat 21 are located at the same height. The second end 224 of each of the two second clamping plates 22 abuts the second end 124 of a respective one of the two first clamping plates 12. The lower bracket 20 has a second opening 220 defined between the second ends 224 of the two second clamping plates 22. The first engaging section 212 of the lower bracket 20 includes a convex protrusion 212a provided on the top of the second back seat 21 and closely fit in the receiving recess 112a of the first engaging portion 112, a slot 212b formed in the protrusion 212a to allow insertion of the insert 112b of the first engaging portion 112, and a locking piece 212c located in the slot 212b and inserted into the locking groove 112c of the first engaging portion 112. The locking piece 212c of the first engaging section 212 is encompassed by the protrusion 212a and is fully received in the slot 212b. The second engaging section 222 of the lower bracket 20 includes two plugs 222a each formed on the top of the second end 224 of a respective one of the two second clamping plates 22 and each closely fit in a respective one of the two sockets 122a of the second engaging portion 122. The second back seat 21 of the lower bracket 20 has a face provided with a second locking hole 210 and has a bottom provided with two support legs 211 each having a substantially arc-shaped profile and each extending toward the second engaging section 222. The second end 124 of each of the two second clamping plates 22 has a bottom provided with a protruding guide piece 221, and the guide pieces 221 of the two second clamping plates 22 extend outwardly relative to each other.

In assembly, the upper bracket 10 is juxtaposed to the lower bracket 20, with the second back seat 21 of the lower bracket 20 abutting the first back seat 11 of the upper bracket 10 and with the second end 224 of each of the two second clamping plates 22 abuts the second end 124 of a respective one of the two first clamping plates 12. At this time, the lower bracket 20 is provided with a first engaging section 212 detachably engaged with the first engaging portion 112 of the upper bracket 10 and a second engaging section 222 detachably engaged with the second engaging portion 122 of the upper bracket 10 so that the upper bracket 10 and the lower bracket 20 are combined together closely. In such a manner, the upper bracket 10 and the lower bracket 20 are made individually, so that each of the upper bracket 10 and the lower bracket 20 has a modularized structure, and the type, color and pattern of the upper bracket 10 and the lower bracket 20 can be changed freely and selectively, thereby enhancing the aesthetic quality and reinforce the strength of the water bottle cage. In addition, the upper bracket 10 and the lower bracket 20 are detached from each other, so that the upper bracket 10 and the lower bracket 20 can be sold and replaced respectively, thereby decreasing the costs of the water bottle cage. Further, the upper bracket 10 and the lower bracket 20 are detached from each other to reduce the volume of the water bottle cage before assembly or when no in use, thereby facilitating packaging, storage and transportation of the water bottle cage.

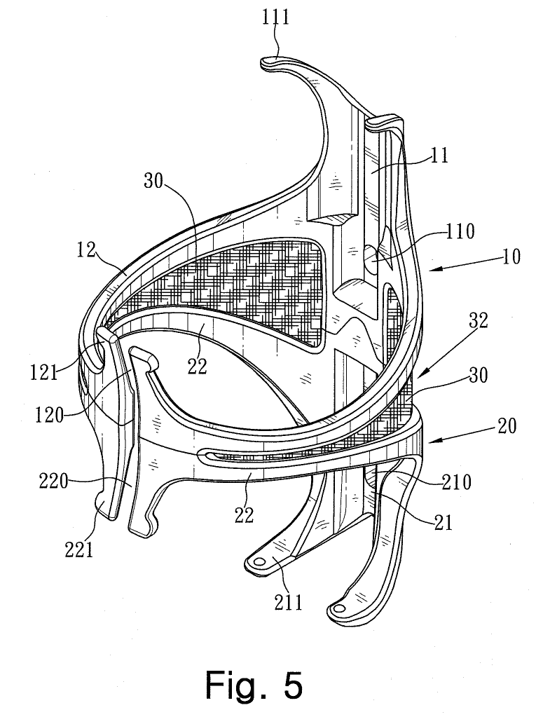

Referring to FIG. 5 with reference to FIGS. 1-4, the water bottle cage further comprises two decorative pieces 30 each mounted between a respective one of the two first clamping plates 12 and a respective one of the two second clamping plates 22 to enhance the aesthetic quality and reinforce the strength of the water bottle cage. Each of the two decorative pieces 30 is made of metal, plastic or carbon fiber. A receiving space 32 is defined between each of the two first clamping plates 12 of the upper bracket 10 and each of the two second clamping plates 22 of the lower bracket 20 to receive each of the two decorative pieces 30. Each of the two first clamping plates 12 of the upper bracket 10 has a bottom provided with a first retaining groove 123 to retain a respective one of the two decorative pieces 30, and each of the two second clamping plates 22 of the lower bracket 20 has a bottom provided with a second retaining groove 223 to retain a respective one of the two decorative pieces 30.

Accordingly, the upper bracket 10 and the lower bracket 20 are made individually, so that each of the upper bracket 10 and the lower bracket 20 has a modularized structure, and the type, color and pattern of the upper bracket 10 and the lower bracket 20 can be changed freely and selectively, thereby enhancing the aesthetic quality and reinforce the strength of the water bottle cage. In addition, the upper bracket 10 and the lower bracket 20 are detached from each other, so that the upper bracket 10 and the lower bracket 20 can be sold and replaced respectively, thereby decreasing the costs of the water bottle cage. Further, the upper bracket 10 and the lower bracket 20 are detached from each other to reduce the volume of the water bottle cage before assembly or when no in use, thereby facilitating packaging, storage and transportation of the water bottle cage. Further, the water bottle cage comprises two decorative pieces 30 each mounted between a respective one of the two first clamping plates 12 and a respective one of the two second clamping plates 22 to enhance the aesthetic quality and reinforce the strength of the water bottle cage.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A water bottle cage, comprising:
an upper bracket;
a lower bracket detachably mounted on and combined with the upper bracket;
wherein the upper bracket is provided with at least one engaging portion;
the lower bracket is provided with at least one engaging section detachably engaged with the at least one engaging portion of the upper bracket.

2. The water bottle cage of claim 1, wherein
the upper bracket is provided with a first engaging portion and a second engaging portion spaced from the first engaging portion;
the lower bracket is provided with a first engaging section detachably engaged with the first engaging portion of the upper bracket and a second engaging section spaced from the first engaging section and detachably engaged with the second engaging portion of the upper bracket.

3. The water bottle cage of claim 2, wherein
the upper bracket includes a first back seat and two first clamping plates provided on two opposite sides of the first back seat;
the lower bracket includes a second back seat abutting the first back seat of the upper bracket and two second clamping plates provided on two opposite sides of the second back seat and juxtaposed to the two first clamping plates of the upper bracket.

4. The water bottle cage of claim 3, wherein
each of the two first clamping plates of the upper bracket has a first end extending outwardly from the first back seat;
the first engaging portion of the upper bracket is provided on a bottom of the first back seat;
the second engaging portion of the upper bracket is provided on a bottom of a second end of each of the two first clamping plates;
each of the two second clamping plates of the lower bracket has a first end extending outwardly from the second back seat;
the first engaging section of the lower bracket is provided on a top of the second back seat;
the second engaging section of the lower bracket is provided on a top of a second end of each of the two second clamping plates.

5. The water bottle cage of claim 4, wherein
the first engaging portion of the upper bracket includes:
a concave receiving recess provided on the bottom of the first back seat;
a protruding insert located in and extended downward from the receiving recess;
a locking groove formed in the protruding insert;
the first engaging section of the lower bracket includes:
a convex protrusion provided on the top of the second back seat and closely fit in the receiving recess of the first engaging portion;
a slot formed in the protrusion to allow insertion of the insert of the first engaging portion;
a locking piece located in the slot and inserted into the locking groove of the first engaging portion.

6. The water bottle cage of claim 4, wherein
the second engaging portion of the upper bracket includes two sockets each formed in the bottom of the second end of a respective one of the two first clamping plates;
the second engaging section of the lower bracket includes two plugs each formed on the top of the second end of a respective one of the two second clamping plates and each closely fit in a respective one of the two sockets of the second engaging portion.

7. The water bottle cage of claim 3, further comprising:
two decorative pieces each mounted between a respective one of the two first clamping plates and a respective one of the two second clamping plates.

8. The water bottle cage of claim 7, wherein
each of the two first clamping plates of the upper bracket has a bottom provided with a first retaining groove to retain a respective one of the two decorative pieces;
each of the two second clamping plates of the lower bracket has a bottom provided with a second retaining groove to retain a respective one of the two decorative pieces.

9. The water bottle cage of claim 7, wherein a receiving space is defined between each of the two first clamping plates of the upper bracket and each of the two second clamping plates of the lower bracket to receive each of the two decorative pieces.

10. The water bottle cage of claim 3, wherein
the first back seat of the upper bracket has a face provided with a first locking hole;
the second back seat of the lower bracket has a face provided with a second locking hole.

11. The water bottle cage of claim 3, wherein
the first back seat of the upper bracket has a top provided with two clamping plates each having a substantially arc-shaped profile and each extending toward the second engaging portion;
the second back seat of the lower bracket has a bottom provided with two support legs each having a substantially arc-shaped profile and each extending toward the second engaging section.

12. The water bottle cage of claim 3, wherein
the second end of each of the two first clamping plates has a top provided with a protruding guide block;
the guide blocks of the two first clamping plates extend outwardly relative to each other.

13. The water bottle cage of claim 3, wherein
the second end of each of the two second clamping plates has a bottom provided with a protruding guide piece;
the guide pieces of the two second clamping plates extend outwardly relative to each other.

14. The water bottle cage of claim 3, wherein
the upper bracket has a first opening defined between the second ends of the two first clamping plates;
the lower bracket has a second opening defined between the second ends of the two second clamping plates.

15. The water bottle cage of claim 3, wherein
each of the two first clamping plates of the upper bracket extends from a middle section of the first back seat and is inclined forward and downward in an oblique manner;
each of the two second clamping plates of the lower bracket extends from a middle section of the second back seat and is inclined forward and upward in an oblique manner.

16. The water bottle cage of claim 3, wherein the second end of each of the two second clamping plates abuts the second end of a respective one of the two first clamping plates.

17. The water bottle cage of claim 3, wherein
the second end of each of the two first clamping plates and the bottom of the first back seat are located at the same height.
the second end of each of the two second clamping plates and the top of the second back seat are located at the same height.

18. The water bottle cage of claim 5, wherein the protruding insert of the first engaging portion has a thickness smaller than that of the receiving recess.

19. The water bottle cage of claim 3, wherein the locking piece of the first engaging section is encompassed by the protrusion and is fully received in the slot.

20. The water bottle cage of claim 1, wherein
the upper bracket has a substantially C-shaped profile;
the lower bracket has a substantially C-shaped profile;
each of the two first clamping plates of the upper bracket has a substantially arc-shaped profile;
each of the two second clamping plates of the lower bracket has a substantially arc-shaped profile.
